(19) United States
(12) Patent Application Publication
(10) Pub. No.: US 2007/0130395 A1
(43) Pub. Date: Jun. 7, 2007

(54) BUS PROCESSING APPARATUS

(76) Inventor: Liang-Kuei Hsu, Chiayi County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,391

(22) Filed: Mar. 21, 2006

(30) Foreign Application Priority Data
Nov. 22, 2005 (TW) 94140909

(51) Int. Cl. G06F 5/00

(52) U.S. Cl. 710/61

(57) ABSTRACT

A bus processing apparatus including a first buffer, a second buffer, an input control unit, an output control unit and a synchronous control unit is provided. The input control unit generates a storing address for deciding to output the transmitter data to either the first buffer or the second buffer according to a first timing and a data enable signal. The synchronous control unit receives and compares the storing address with a reading address in accordance with a second timing in order to output a data ready signal. The output control unit generates the reading address according to the second timing and the data ready signal, and reads the data stored in the first buffer or in the second buffer according to the reading address to output a receiver data to the receiver. Wherein, the frequency of second timing is not lower than the frequency of first timing.

### CROSS-REFERENCE TO RELATED APPLICATION

This application claims the priority benefit of Taiwan application serial no. 94140909, filed on Nov. 22, 2005. All disclosure of the Taiwan application is incorporated herein by reference.

### BACKGROUND OF THE INVENTION

1. Field of the Invention

The present invention generally relates to a bus processing apparatus, and more particularly, to a non-synchronous bus processing apparatus.

2. Description of Related Art

A sampling frequency higher than two times of the input signal is used by the conventional non-synchronous bus processing apparatus to sample the non-synchronous bus signal. However, the sampling frequency usually plays a major role of deciding the difficulty of the system design, the complexity of the system architecture, and the system power consumption.

FIG. 1 schematically shows a block diagram of a conventional non-synchronous bus processing apparatus circuit. Referring to FIG. 1, the conventional non-synchronous bus processing apparatus circuit comprises a positive-edge triggered flip-flop 102 and a negative-edge triggered flip-flop 104. Wherein, Din is a transmitter data of the previous stage, CK1 is a first timing, DinH is an output of the flip-flop 102, P0 is an enable signal, CK2 is a second timing, and Dout is an output of the flip-flop 104. Here, Dout also works as the output of the non-synchronous bus processing apparatus and the receiver data of a next stage circuit.

The flip-flop 102 receives the transmitter data Din of the previous stage and the first timing CK1, extracts the transmitter data Din according to the timing CK1 of the transmitter, and holds the extracted data for a certain period of time. The flip-flop 104 is triggered by the timing CK2 of the receiver, and the flip-flop 104 also decides whether to latch the output DinH of the flip-flop 102 in accordance with the timing CK2 based on the enable signal P0 received by the enable input terminal EN. When the flip-flop 104 is enabled by the enable signal P0, the output DinH of the flip-flop 102 is extracted according to the second timing CK2, and a receiver data Dout required by the next stage (i.e. the receiver) is provided after the extracted data is maintained for a certain period of time. Wherein, the enable signal P0 is a signal that is generated in accordance with the first timing CK1.

FIG. 2 schematically shows a timing diagram of the signals in the conventional non-synchronous bus processing apparatus of FIG. 1. Referring to FIG. 2, it is obvious that the frequency of the receiver timing CK2 is usually higher than two times of the frequency of the transmitter timing CK1. If the frequency of the second timing CK2 is lower than two times of the first timing CK1, the second timing CK2 fails to accurately extract the output DinH of the flip-flop 102, thus the data transmitted through the non-synchronous bus processing apparatus is incorrect.

Since the frequency of the conventional second timing CK2 must be at least two times higher than the frequency of the first timing CK1, the higher the frequency, the more complex the circuit configuration will be. Accordingly, it is difficult to design the system due to the complexity of the system architecture, and the power consumption of the system is high.

### SUMMARY OF THE INVENTION

Therefore, it is an object of the present invention to provide a bus processing apparatus, such that the data can be correctly transmitted between a transmitter and a receiver in a case where the frequency of the receiver timing is lower that two times of the frequency of the transmitter timing (however, the frequency of the receiver timing must be greater than or equal to the frequency of the transmitter timing). Accordingly, the present invention simplifies the system design and architecture, and the power consumption the system comparatively lower than that of the conventional non-synchronous bus processing apparatus.

In accordance with the objects of the present invention mentioned above and others, a bus processing apparatus including a first buffer, a second buffer, an input control unit, an output control unit and a synchronous control unit is provided. The input control unit generates a storing address according to a first timing and a data enable signal, and decides to output the transmitter data to either the first buffer or the second buffer in accordance with the storing address. The synchronous control unit receives the storing address in accordance with a second timing, and compares the received storing address with a reading address in order to output a data ready signal. The output control unit generates a reading address according to the second timing and the data ready signal, and reads the data stored in the first buffer or the second buffer in accordance with the reading address to output a receiver data to the receiver. Wherein, the frequency of second timing is not lower than the frequency of first timing.

The present invention uses two flip-flops to store the transmitter data on the corresponding addresses of two buffers according to a storing address generated by the input control unit, and to read the corresponding data stored in these two buffers according to a reading address generated by the output control unit. Therefore, the frequency of the first timing CK1 used by the input control unit can be configured as the same as the frequency and the second timing CK2 used by the output control unit. Accordingly, the design of the system design can be simplified and the system architecture is less complex, and the power consumption of the system is relatively low.

### BRIEF DESCRIPTION DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a block diagram of a conventional non-synchronous bus processing apparatus circuit.

FIG. 2 schematically shows a timing diagram illustrating the operation of the conventional non-synchronous bus processing apparatus.

FIG. 3 schematically shows a block diagram of a circuit according to a preferred embodiment of the present invention.

FIG. 4 schematically shows a timing diagram illustrating the operation of the circuit according to the preferred embodiment of the present invention.

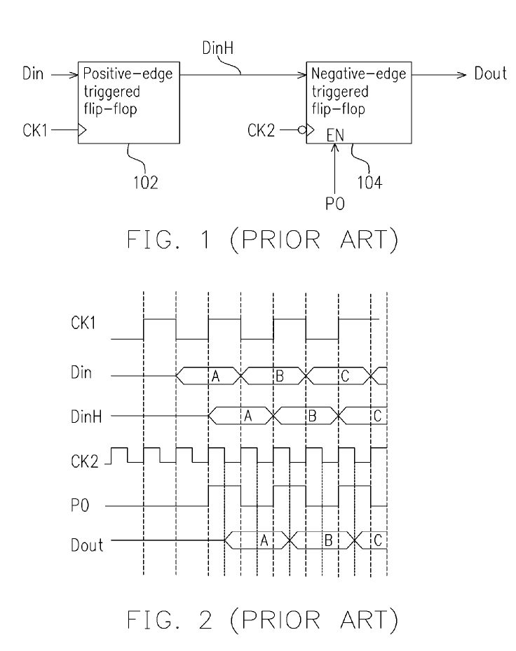

### DESCRIPTION PREFERRED EMBODIMENTS

In order to reduce the system power consumption and simplify the system design and architecture, the present invention provides a non-synchronous bus processing apparatus that is different from the one of the prior art, and the detail technique is described in detail with referring to the embodiments shown in the accompanying drawings hereinafter.

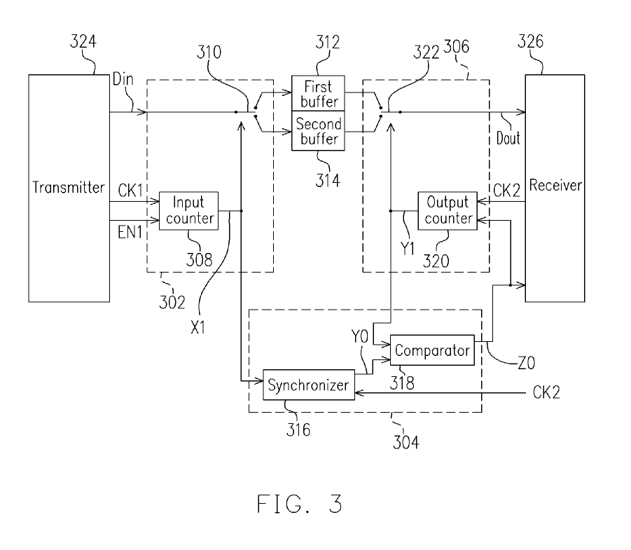

FIG. 3 schematically shows a block diagram of a circuit according to a preferred embodiment of the present invention. Referring to FIG. 3, the bus processing apparatus comprises an input control unit 302, a synchronous control unit 304, an output control unit 306, a first buffer 312 and a second buffer 314. The bus processing apparatus is used as a data transmission interface between a transmitter 324 and a receiver 326.

When the transmitter 324 starts to transmit the data to the receiver 326, the input control unit 302 generates a storing address X1 according to the data enable signal EN1 and the first timing CK1 of the transmitter 324, and decides whether or not to provide the transmitter data Din output from the transmitter 324 to either the first buffer 312 or to the second buffer 314 according to the storing address X1. The synchronous control unit 304 receives the storing address X1 output from the input control unit 302 according to the second timing CK2 of the receiver 326. The synchronous control unit 304 further compares the storing address X1 output from the input control unit 302 with a reading address Y1 output from the output control unit 306, and provides a data ready signal Z0 according to the comparison result.

The output control unit 306 generates the reading address Y1 according to the second timing CK2 of the receiver 326 and the data ready signal Z0 output from the synchronous control unit 304. In addition, the output control unit 306 decides to read the data stored in the first buffer 312 or the second buffer 324 according to the reading address Y1, so as to provide the receiver data Dout to the receiver 326. The data ready signal Z0 mentioned above is used to notify the receiver 326 that the data is ready to transmit. Therefore, once the data ready signal Z0 is enabled, the receiver 326 starts to receive the receiver data Dout provided by the output control unit 306. Wherein, the frequency of the second timing CK2 is not lower than that of the first timing CK1.

In the present embodiment, the input control unit 302 comprises an input counter 308 and a first switch 310. The synchronous control unit comprises a synchronizer 316 and a comparator 318. In addition, the output control unit 306 may comprise an output counter 320 and a second switch 322.

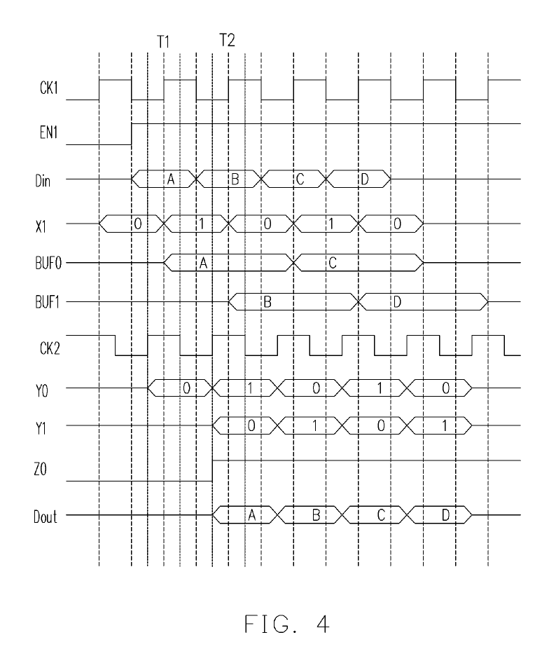

FIG. 4 schematically shows a timing diagram illustrating the operation of the circuit according to the preferred embodiment of the present invention. Wherein, the CK1, EN1, Din, X1, CK2, Y0, Y1, Z0 and Dout shown in FIG. 4 all correspond to the CK1, EN1, Din, X1, CK2, Y0, Y1, Z0 and Dout in FIG. 3. In FIG. 4, the timing BUF0 represents the data timing inside the first buffer 312, and the timing BUF1 represents the data timing inside the second buffer 314. Referring to FIGS. 3 and 4, where the data enable signal EN1 is used to decide a starting address of the valid data. When the data is continuously provided to the transmitter at each first timing CK1, the data enable signal EN1 can be neglected. It is assumed herein that the initial value of the storing address X1 output by the input counter 308 is 0, namely it is assumed that the initial state of the first switch 310 is selectively connected to the first buffer 312. At the first rising edge T1 of the first timing CK1, the input data A of the transmitter data is stored into the first buffer 312 (at the timing BUF0 of FIG. 4), and the value of the input counter 308 changes to 1. At the second rising edge T2 of the first timing CK1, the input data B is stored into the second buffer 314 (at the timing BUF1 of FIG. 4), and the value of the input counter 308 changes to 0. In addition, both of the input data A and B are respectively maintained for a period of two cycles within the timings BUF0 and BUF1, and the input data are interleavedly buffered in the timings BUF0 and BUF1.

According to an embodiment of the present invention, the second timing CK2 is different from the first timing CK1, and the frequency of the second timing CK2 is greater than or equal to the frequency of the first timing CK1. The storing address X1 provided by the input counter 308 is sampled and synchronized with the second timing CK2 by the synchronizer 316, and the sampling result Y0 is subsequently output by the synchronizer 316. Then, the sampling result Y0 is compared with the reading address Y1 output from the output counter 320 by the comparator 318, and a data ready signal Z0 is generated according to the comparison result in order to notify the receiver 326 to receive the data. The data ready signal Z0 output by the comparator 318 is further transmitted to the output counter 320. Then, the output counter 320 counts the second timing CK2 according to the data ready signal Z0, generates the reading address Y1 according to the counting result, and transmits the reading address Y1 to the comparator 318 and the second switch 322. The second switch 322 decides to transmit the data stored in the first buffer 312 or in the second buffer 314 to the receiver 326 according to the reading address Y1.

If the sampling result Y0 is different from the reading address Y1, which indicates there are data temporally stored in the buffer, meanwhile the data ready signal Z0 is changed to a high level, and the input data A is sent to the data receiver 326. Once the data ready signal Z0 is in the high level, the output counter 320 starts to count the second timing CK2. The operations of the input data C and D are the same as the operations of the input data A and B, thus its detail is omitted herein.

If the step of comparing the sampling result Y0 that is sampled and synchronized with the second timing CK2 with the reading address Y1 output from the output counter 320 is continuously performed, the data temporarily stored in the buffer is synchronized with the second timing CK2 and the synchronized data is then interleavedly output by the first and second buffers 312 and 314.

The first buffer 312 and the second buffer 314 of the previous embodiment may be the Static Random Access Memory (SRAM), the latches, the flip-flops, or any memory device that can temporarily store data. In addition, the synchronizer 316 may be implemented by a flip-flop, and the comparator 318 may be implemented by an XOR gate.

In summary, two buffers are used in the non-synchronous bus processing apparatus provided by the present invention to interleavedly access data, and the data transmitted from the transmitter is maintained for a period of two transmitter timing (i.e. the first clock CK1) cycles. Therefore, the frequency of the reading clock used by the receiver (i.e. the second clock CK2) need not be higher than two times of the frequency of the transmitter clock. Accordingly, compared to the conventional non-synchronous bus processing apparatus, the present invention simplifies the system design and architecture, and the system power consumption is relatively lower.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A bus processing apparatus serving as a data transmission interface between a transmitter and a receiver, comprising:
a first buffer, for storing the data;
a second buffer, for storing the data;
an input control unit, electrically coupled to an input terminal of the first buffer and an input terminal of the second buffer, for generating a storing address according to a first timing, and deciding to output a transmitter data output from the transmitter to either the first buffer or to the second buffer according to the storing address;
an output control unit, electrically coupled to an output terminal of the first buffer and an output terminal of the second buffer, for generating a reading address according to a second timing and a data ready signal, and reading the data stored in the first buffer or in the second buffer according to the reading address for outputting the receiver data to the receiver, wherein a frequency of the second timing is not lower than a frequency of the first timing; and
a synchronous control unit, electrically coupled to the input control unit and the output control unit, for receiving the storing address according to the second timing, comparing the received storing address with the reading address, and providing the data ready signal according to the comparison result.

2. The bus processing apparatus of claim 1, wherein the input control unit comprises:
an input counter, for performing a counting according to the first timing and providing the storing address according to the counting result; and
a first switch, electrically coupled to an output terminal of the input counter, the input terminal of the first buffer and the input terminal of the second buffer, for receiving the transmitter data, and deciding to transmit the transmitter data to either the first buffer or to the second buffer according to the storing address.

3. The bus processing apparatus of claim 2, wherein the input counter further receives a data enable signal and decides whether to perform the counting according to the data enable signal.

4. The bus processing apparatus of claim 1, wherein the output control unit comprises:
an output counter, for performing a counting according to the second timing, and providing the reading address according to the counting result, wherein the output counter further decides whether to perform the counting according to the data ready signal; and
a second switch, electrically coupled to an output terminal of the output counter, the output terminal of the first buffer and the output terminal of the second buffer, for selectively outputting the data stored in the first buffer or in the second buffer according to the reading address as the receiver data required by the receiver.

5. The bus processing apparatus of claim 1, wherein the synchronous control unit comprises:
a synchronizer, for sampling the storing address according to the second timing and providing a sampling result; and
a comparator, electrically coupled to the synchronizer, for comparing the reading address with the sampling result of the synchronizer, and outputting a comparison result as the data ready signal.

6. The bus processing apparatus of claim 5, wherein the synchronizer comprises a flip-flop.

7. The bus processing apparatus of claim 5, wherein the comparator comprises an XOR gate.

8. The bus processing apparatus of claim 1, wherein the first buffer and the second buffer are Static Random Access Memory (SRAM).

9. The bus processing apparatus of claim 1, wherein the first buffer and the second buffer are latches.

10. The bus processing apparatus of claim 1, wherein the first buffer and the second buffer are flip-flops.
